(19) United States
(12) Patent Application Publication
(10) Pub. No.: US 2025/0249692 A1
(43) Pub. Date: Aug. 7, 2025

(54) PROCESSING DEVICE, PRINTING APPARATUS

(71) Applicant: SEIKO EPSON CORPORATION, Tokyo (JP)

(72) Inventors: Hideki OKADA, SHIOJIRI-SHI (JP); Osamu KATSUDA, MATSUMOTO-SHI (JP)

(21) Appl. No.: 19/044,809

(22) Filed: Feb. 4, 2025

(30) Foreign Application Priority Data
Feb. 7, 2024 (JP) 2024-016907

(51) Int. Cl. B41J 3/407; B41J 11/00

(52) U.S. Cl. CPC B41J 3/4078; B41J 11/0015

(57) ABSTRACT

A processing device is a processing device that performs texture processing treatment on a printed fabric, the processing device including an abutting portion including a plurality of protruding portions that abut on the fabric, and a vibration applying unit configured to apply vibration to the abutting portion, wherein the abutting portion includes a first abutting portion and a second abutting portion disposed with the fabric interposed therebetween, the vibration applying unit includes a first driving unit that applies vibration to the first abutting portion and a second driving unit that applies vibration to the second abutting portion, and a waveform of the vibration applied to the first abutting portion by the first driving unit and a waveform of the vibration applied to the second abutting portion by the second driving unit are opposite in phase.

The present application is based on, and claims priority from JP Application Serial Number 2024-016907, filed Feb. 7, 2024, the disclosure of which is hereby incorporated by reference herein in its entirety.

### BACKGROUND

### 1. Technical Field

The present disclosure relates to a processing device, and a printing apparatus including the processing device.

### 2. Related Art

In the related art, printing apparatuses that eject ink onto fabric to record images have been known. The fabric on which record is performed by such a printing apparatus is subjected to texture processing treatment by a processing device for performing texture processing in order to enhance texture as a post-process.

For example, JP 2023-46884 A discloses a processing device that includes a pair of abutting portions that abut on front and back surfaces of a transported fabric and two vibration generation sources that apply vibration to the abutting portions, respectively, and performs texture processing treatment by applying vibration to the fabric.

However, there was room for improvement for the processing device in JP 2023-46884 A. Specifically, vibration and vibration sounds caused by vibration energy generated from the vibration generation sources are transmitted to a periphery of the processing device, thus there was a problem that an installation environment was limited.

That is, there has been a demand for a processing device with less vibration and vibration sound and a high degree of freedom in installation environment.

### SUMMARY

A processing device according to an aspect of the present application is a processing device that performs texture processing treatment on a printed fabric, the processing device including an abutting portion including a plurality of protruding portions that abut on the fabric, and a vibration applying unit configured to apply vibration to the abutting portion, wherein the abutting portion includes a first abutting portion and a second abutting portion disposed with the fabric interposed therebetween, the vibration applying unit includes a first driving unit that applies vibration to the first abutting portion and a second driving unit that applies vibration to the second abutting portion, and a waveform of the vibration applied to the first abutting portion by the first driving unit and a waveform of the vibration applied to the second abutting portion by the second driving unit are opposite in phase.

A printing apparatus according to an aspect of the present application includes the processing device described above and a printing unit configured to perform printing on the fabric, and further includes, when the processing device including the first abutting portion and the second abutting portion is defined as a first processing device, a second processing device disposed downstream of the first processing device in a transport direction of the fabric, wherein the second processing device includes a third abutting portion and a fourth abutting portion disposed with the fabric interposed therebetween.

### BRIEF DESCRIPTION OF THE DRAWINGS

FIG. 1 is a schematic configuration diagram of a printing system according to Embodiment 1.

FIG. 2 is a side view of a processing device.

FIG. 3 is an exploded perspective view of the processing device.

FIG. 4 is a perspective view of a second driving unit viewed in P view in FIG. 3.

FIG. 5 is an explanatory view of a scotch yoke mechanism.

FIG. 6 includes waveform diagrams showing driving modes of a first driving unit and a second driving unit by waveforms.

FIG. 7 is a side view illustrating an aspect of a protruding portion of a first processing device.

FIG. 8 is a side view illustrating an aspect of a protruding portion of a second processing device.

FIG. 9 is a diagram illustrating a disposition mode of a processing device according to Embodiment 2.

### DESCRIPTION OF EMBODIMENTS

### Embodiment 1

### Overview of Pinging System

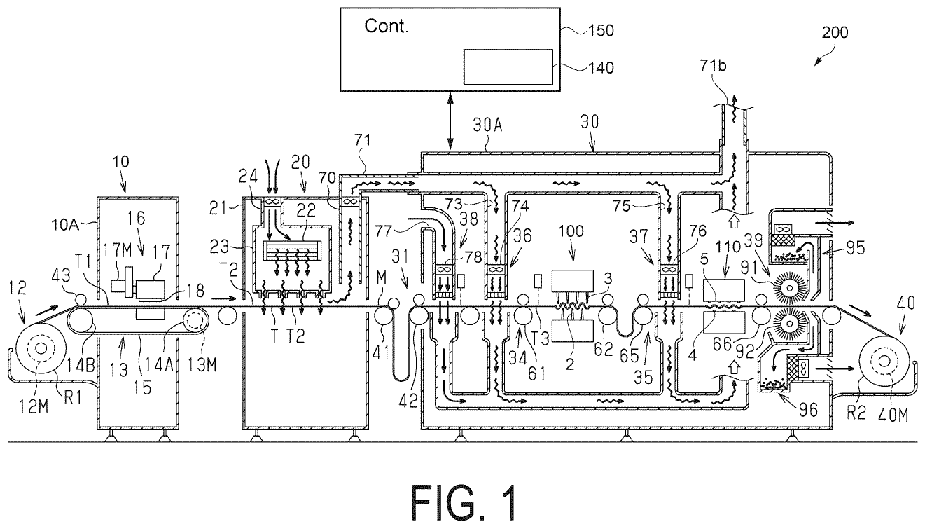

FIG. 1 is a schematic configuration diagram of a printing system according to Embodiment 1.

A printing apparatus 200 according to the embodiment is a printing apparatus that records an image on a fabric M, and is configured to include a processing unit 30 that performs processing of improving a texture of the fabric M on the printed fabric M.

The printing apparatus 200 includes a printing unit 10, a drying unit 20, the processing unit 30, a control device 150, and the like. In the printing apparatus 200, the fabric M is transported by a roll-to-roll method. Specifically, after the fabric M before printing is pulled out from a first roll body R1, printing is performed by the printing unit 10, drying is performed by the drying unit 20, and then the fabric M subjected to texture improvement processing by the processing unit 30 is wound as a second roll body R2 by a winding unit 40.

### Configuration of Printing Unit

The printing unit 10 includes a housing 10A, and a feeding unit 12 is supported outside the housing 10A. The feeding unit 12 includes a feeding motor 12M that is a drive source for rotating the mounted first roll body R1 in a feeding direction.

The printing unit 10 includes a transport unit 13 that transports the fabric M fed from the feeding unit 12. The transport unit 13 includes a driving roller 14A, a driven roller 14B, and an endless transporting belt 15 wound around both the rollers 14A and 14B. The transport unit 13 includes a transport motor 13M that is a drive source for rotating the driving roller 14A. The transport motor 13M drives to rotate the transporting belt 15. The fabric M above the transporting belt 15 is transported in a transport direction indicated by an arrow as the transporting belt 15 rotates. The driven roller 14B is paired with a roller 43, and supplies the fabric M onto the transporting belt 15 while nipping the fabric M between the driven roller 14B and the roller 43.

A printing section 16 that performs printing on the fabric M transported along a first transport path T1 is disposed inside the housing 10A as illustrated in FIG. 1.

The printing section 16 includes a printing head 18. The printing head 18 ejects liquid such as ink supplied from a liquid container such as an ink cartridge or an ink tank, which is not illustrated, to the fabric M. The liquid container contains the same type of liquid as the liquid ejected by the printing head 18. The liquid ejected by the printing head 18 is not limited to ink, and includes a pre-treatment liquid that is ejected before printing is performed on the fabric M, a post-treatment liquid ejected after printing is performed on the fabric M, or the like. Thus, printing processing performed on the fabric M by the printing unit 10 may include processing of ejecting the pre-treatment liquid, the post-treatment liquid, and the like onto the fabric M, in addition to the processing of ejecting ink onto the fabric M.

For example, when the printing unit 10 is configured to perform color printing using N colors of ink, N liquid containers respectively containing the N colors of ink are mounted at a mounting portion provided at a predetermined position in the printing unit 10. When the N colors are, for example, four colors, four liquid containers respectively containing the four colors of ink including cyan, magenta, yellow, and black are mounted at the mounting portion. Color printing is not limited to printing in three colors or four colors, and may be printing in one color, two colors, or printing in five or more colors.

The printing unit 10 is, for example, a serial-type digital textile printing printer. The serial-type printing section 16 includes a carriage 17 configured to be movable in a width direction of the fabric M, and the printing head 18 fixed to the carriage 17. The printing head 18 is fixed to a surface of the carriage 17 on a side facing the first transport path T1, and reciprocates in a width direction X together with the carriage 17. The printing head 18 includes a plurality of nozzles (not illustrated) that open at a nozzle surface that is a surface facing the fabric M.

For the carriage 17, a carriage motor 17M is a drive source. The printing unit 10 includes a power transmission mechanism (not illustrated) that converts power of the carriage motor 17M into linear movement of the carriage 17 in the width direction X. The power transmission mechanism is, for example, a belt-type power transmission mechanism. The carriage 17 is guided by a guide rail (not illustrated) so as to be movable in the width direction X. The carriage 17 is fixed to a portion of an endless timing belt constituting the belt-type power transmission mechanism, and the carriage motor 17M is driven to rotate the timing belt forward and backward, and thus the carriage 17 reciprocates in the width direction X.

The printing head 18 performs printing on the fabric M as liquid such as ink is ejected from the nozzles while the carriage 17 is moving in the width direction X. Moving the printing head 18 once in the width direction X will be referred to as one pass. An image or the like is printed on the fabric M based on print data by repeating printing operation in which the carriage 17 moves in the width direction X and the printing head 18 performs printing for one pass or a plurality of passes, and transport operation in which the fabric M is transported to a next printing position in an alternating manner.

Note that the printing section 16 may be of a line printing type. The line printing-type printing section 16 includes the line-type printing head 18, a so-called line head, including a plurality of nozzles in a range across an entire width of an assumed maximum width of the fabric M. In the line printing-type printing unit 10, the transport unit 13 transports the fabric M at a constant speed. The printing head 18 ejects liquid such as ink from the nozzles onto the fabric M transported at the constant speed to print an image or the like on the fabric M.

### Configuration of Drying Unit

The drying unit 20 performs drying processing on the fabric M that has undergone the printing processing by the printing unit 10, that is, the fabric M on which printing has been completed.

The drying unit 20 includes a second transport path T2 through which the fabric M is transported in the housing 21. Furthermore, the drying unit 20 includes a heater 22 that is a heat source to dry the fabric M in the housing 21. The heater 22 is accommodated in an air duct 23 disposed at a position above the second transport path T2 in the housing 21. A fan 24 is disposed at a portion that communicates with an outside of the housing 21 in the air duct 23. When the fan 24 is driven, air is taken into the air duct 23 from the outside of the housing 21, the air taken into the air duct is heated while passing through the heater 22, and the heated air is blown as hot air or warm air from a vent of the air duct 23 to a print surface of the fabric M on the second transport path T2.

Thus, the liquid such as ink printed on the fabric M in the printing unit 10 is dried while the fabric M is transported along the second transport path T2 of the drying unit 20. Then, the fabric M subjected to the drying processing is transported from the drying unit 20 to the processing unit 30.

Further, exhaust heat in the drying unit 20 is suctioned by an exhaust fan 70 and discarded from an exhaust port 71b via an exhaust duct 71.

A buffer unit 31 is provided between the drying unit 20 and the processing unit 30. The buffer unit 31 includes two roller pairs 41 and 42. As illustrated in FIG. 1, the buffer unit 31 causes a predetermined length of slack in the fabric M between the roller pair 41 and the roller pair 42. The slack of the fabric M serves as a buffer portion between the printing unit 10 and the processing unit 30. For example, even when the printing unit 10 temporarily stops the transport of the fabric M, the processing unit 30 can continue the processing for an amount of the slack of the fabric M formed in the buffer unit 31.

### Configuration of Processing Unit

The processing unit 30 includes a processing device 100, a processing device 110, and the like. The processing device 100 corresponds to a first processing device, and the processing device 110 corresponds to a second processing device.

The fabric M is transported along a third transport path T3, the processing device 100 is provided upstream in the third transport path T3, and the processing device 110 is provided downstream thereof.

As illustrated in FIG. 1, the processing device 100 includes a first abutting portion 2 and a second abutting portion 3 that are disposed with the fabric M interposed therebetween, and performs texture processing treatment by applying vibration to the fabric M from front and back surfaces thereof. Similarly, the processing device 110 includes a third abutting portion 4 and a fourth abutting portion 5 that are disposed with the fabric M interposed therebetween. In other words, the processing device 110 as the second processing device is disposed downstream of the processing device 100 in the transport direction of the fabric M. Note that details of the processing device 100 and the processing device 110 will be described later.

The processing unit 30 is provided with a cooling unit 38, heating units 36, 37, a tension adjustment units 34, 35, and a cleaning unit 39.

The cooling unit 38 includes a cooling duct portion 77 that captures outside air from an outside of a housing 30A, and a cooling fan 78 disposed in the cooling duct portion 77. The cooling unit 38 cools the fabric M, which is heated in the drying processing by the drying unit 20 and has a temperature higher than a room temperature, to a temperature closer to the room temperature.

The heating unit 36 includes a duct portion 73 that branches from the exhaust duct 71, and a heating fan 74 disposed in the duct portion 73. The heating unit 36 blows waste heat air by driving the heating fan 74 and heats the fabric M before being processed by the processing device 100. Since the fabric M is warmed and softened by the heating, the processing in the processing device 100 can be efficiently performed.

The heating unit 37 includes a duct portion 75 that branches from the exhaust duct 71, and a heating fan 76 disposed in the duct portion 75. The heating unit 37 blows the waste heat air by driving the heating fan 76 and heats the fabric M before being processed by the processing device 110. Since the fabric M is warmed and softened by the heating, the processing in the processing device 110 can be efficiently performed.

The tension adjustment unit 34 includes two sets of roller pairs 61 and 62 that interpose the fabric M. The roller pair 61 is provided upstream of the processing device 100, and the roller pair 62 is provided downstream of the processing device 100. The tension adjustment unit 34 adjusts tension of the fabric M to be processed by the processing device 100 by the two sets of roller pairs 61 and 62 to tension suitable for the processing of the processing device 100.

The tension adjustment unit 35 includes two sets of roller pairs 65 and 66 that interpose the fabric M. The roller pair 65 is provided upstream of the processing device 110, and the roller pair 66 is provided downstream of the processing device 110. The tension adjustment unit 35 adjusts the tension of the fabric M to be processed by the processing device 110 by the two sets of roller pairs 65 and 66 to tension suitable for the processing of the processing device 110.

The cleaning unit 39 includes removal members 91 and 92 that clean the fabric M while in contact with the fabric M. The removal member 91 cleans the fabric M while in contact with the print surface of the fabric M. The removal member 92 cleans the fabric M while in contact with a back surface, which is a surface opposite to the print surface of the fabric M. The removal members 91 and 92 are rotary brushes, for example. The removal members 91 and 92 each have a width dimension that allows an entire region of the fabric M in the width direction to be cleaned.

Furthermore, the cleaning unit 39 includes collecting units 95 and 96 that collect discarded powder such as fiber powder generated by the removal members 91 and 92 cleaning the fabric M. The collecting unit 95 is a discarded powder box that collects the discarded powder generated from the removal member 91, and the collecting unit 96 is a discarded powder box that collects the discarded powder generated from the removal member 92.

The fabric M for which the processing in the processing unit 30 is completed is wound around the second roll body R2 by a winding motor 40M of the winding unit 40.

The control device 150 is a control circuit configured to include one or a plurality of processors, and integrally controls operation of each unit of the printing apparatus 200 by operating in accordance with a control program stored in a storage circuit (not illustrated). The control device 150 includes a driving unit 140 that drives and controls the processing devices 100 and 110.

In other words, the printing apparatus 200 includes the processing devices 100, 110, and the printing unit 10 that performs printing on the fabric M, and when the processing device 100 including the first abutting portion 2 and the second abutting portion 3 is defined as the first processing device, the printing apparatus 200 further includes the processing device 110 as the second processing device disposed downstream of the processing device 100 in the transport direction of the fabric M, and the processing device 110 includes the third abutting portion 4 and the fourth abutting portion 5 disposed with the fabric M interposed therebetween.

### Configuration of Processing Device

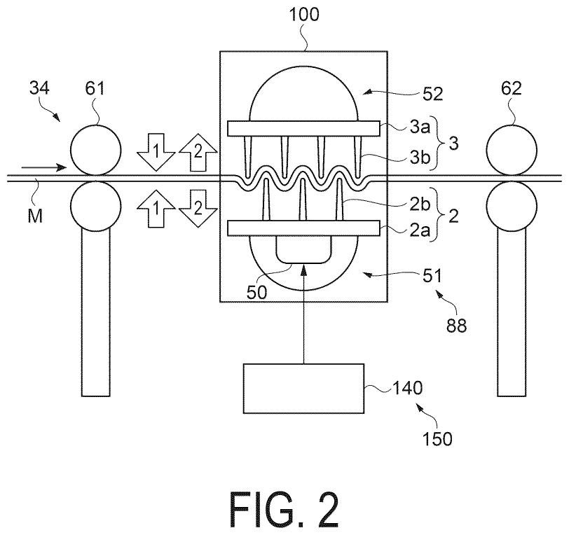

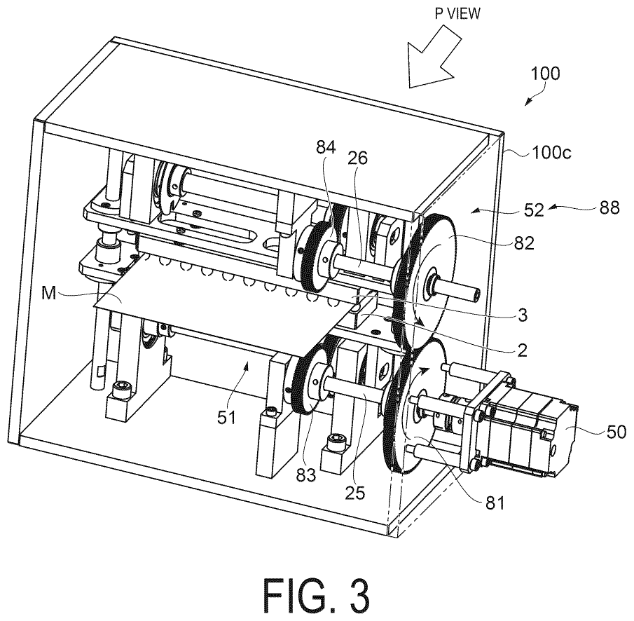

FIG. 2 is a side view of the processing device, and corresponds to FIG. 1. FIG. 3 is an exploded perspective view of the processing device.

The processing device 100 includes a vibration applying unit 88, the first abutting portion 2, the second abutting portion 3, and the like. The vibration applying unit 88 includes a first driving unit 51 and a second driving unit 52.

The first driving unit 51 is disposed below the fabric M and drives the first abutting portion 2. The first abutting portion 2 includes a support plate 2a and a plurality of protruding portions 2b protruding from the support plate 2a. The second driving unit 52 is disposed above the fabric M and drives the second abutting portion 3. The second abutting portion 3 includes a support plate 3a and a plurality of protruding portions 3b protruding from the support plate 3a. As illustrated in FIG. 2, the fabric M is inserted into a gap between the first abutting portion 2 and the second abutting portion 3. The plurality of protruding portions 2b and the plurality of protruding portions 3b are alternately disposed in plan view.

As illustrated in FIG. 3, a driving motor 50 is provided on the first driving unit 51 side.

A rotary shaft of the driving motor 50 is directly coupled to a toothed gear 81. A transmission shaft 25 is coupled to the toothed gear 81, and the transmission shaft 25 is provided with a toothed gear 83. As will be described in detail later, the first driving unit 51 is driven by the toothed gear 83.

A toothed gear 82 of the same size is disposed above the toothed gear 81. Here, as illustrated in FIG. 3, the toothed gear 82 rotates in a direction opposite to a rotation direction of the toothed gear 81. A transmission shaft 26 is coupled to the toothed gear 82, and the transmission shaft 26 is provided with a toothed gear 84. The second driving unit 52 is driven by the toothed gear 84. Thus, the first driving unit 51 and the second driving unit 52 are driven in opposite phases. Note that although the above-described units are housed in a housing 100c of the processing device 100, some parts of the housing 100c are removed in FIG. 3 to illustrate an internal structure.

### Scotch Yoke Mechanism

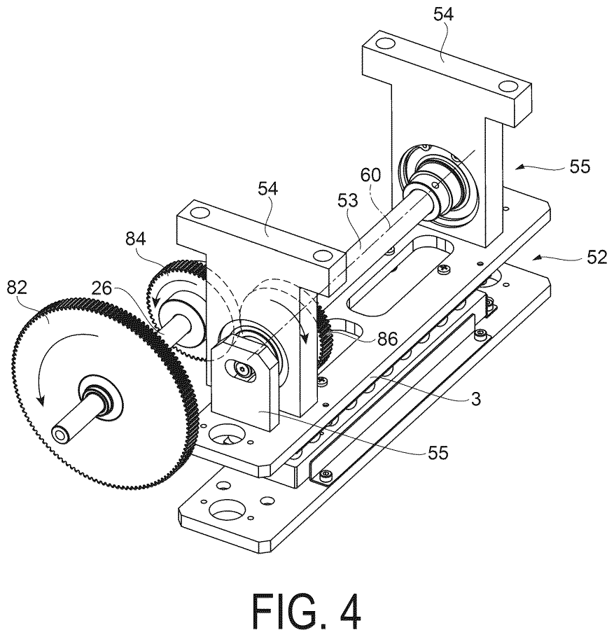

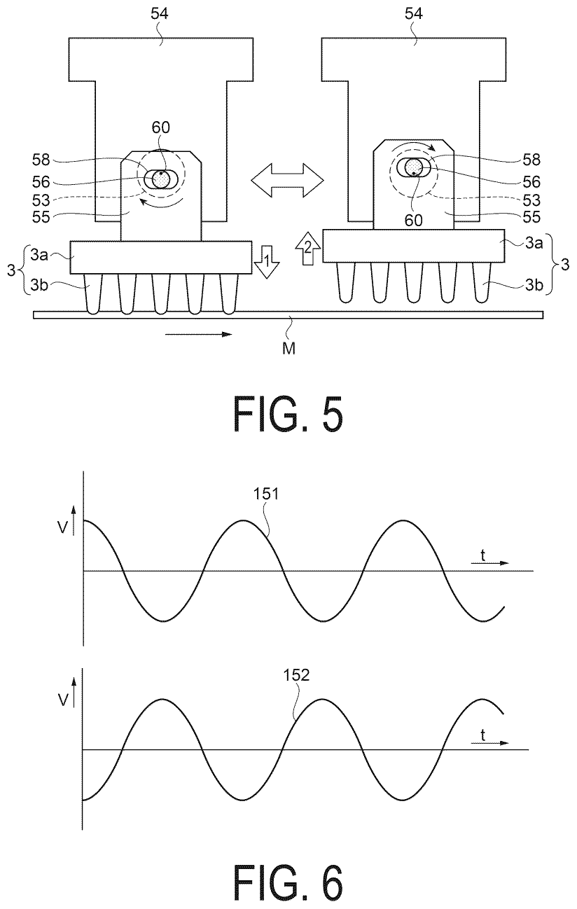

FIG. 4 is a perspective view of the second driving unit viewed in P view in FIG. 3. FIG. 5 is an explanatory view of a scotch yoke mechanism.

Here, the scotch yoke mechanism used in the vibration applying unit 88 will be described using the second driving unit 52. Note that the first driving unit 51 has the same configuration.

As illustrated in FIG. 4, the second driving unit 52 includes a driving shaft 53, a toothed gear 86, a pair of bearing portions 54, a pair of driving bodies 55, and the like.

The pair of bearing portions 54 are each a bearing portion that supports the driving shaft 53 so as to be rotatable about a rotation axis 60, and are fixed to the housing 100c (FIG. 3) of the processing device 100. Note that illustration of the housing 100c is omitted in FIG. 4. The rotation axis 60 is also referred to as a center of rotation 60.

The driving shaft 53 is provided with the toothed gear 86. The toothed gear 86 is coupled to the toothed gear 84, and the toothed gear 86 rotates in a direction opposite to a rotation direction of the toothed gear 84. As the toothed gear 86 rotates, the driving shaft 53 rotates therewith. One end of the driving shaft 53 penetrates the bearing portion 54, and the driving body 55 is attached to the one end.

As illustrated in FIG. 5, the one end of the driving shaft 53 is provided with an eccentric pin 56. The eccentric pin 56 is a cylindrical pin, and a center thereof is eccentric from the center of rotation 60 of the driving shaft 53. One end of the driving body 55 is fixed to the support plate 3a of the second abutting portion 3. An elongated hole 58 is provided on another end side of the driving body 55. A longitudinal direction of the elongated hole is along the transport direction of the fabric M. The driving body 55 is attached in a state where the eccentric pin 56 of the driving shaft 53 is inserted into the elongated hole 58. Note that the eccentric pin 56 and the driving body 55 having the same configuration are provided on another end side (FIG. 4) of the driving shaft 53.

The eccentric pin 56 of the driving shaft 53 and the elongated hole 58 of the driving body 55 constitute the scotch yoke mechanism. More specifically, when the driving shaft 53 rotates, the eccentric pin 56 reciprocates the driving body 55 in a direction intersecting the elongated hole 58. A state of abutting on the fabric M indicated by a white arrow 1 as illustrated on a left side of FIG. 5, and a state of separating away from the fabric M indicated by a white arrow 2 are repeated. In other words, the second abutting portion 3 repeatedly performs operation of striking the fabric M and separating away from the fabric M.

Referring back to FIG. 2.

The first driving unit 51 also includes the same scotch yoke mechanism as the second driving unit 52, thus as illustrated in FIG. 2, the first abutting portion 2 and the second abutting portion 3 synchronously repeat the state of abutting on the fabric M indicated by the white arrow 1 and the state of separating from the fabric M indicated by the white arrow 2.

In other words, the processing device 100 includes the abutting portions including the plurality of protruding portions 2b and 3b that abut on the fabric M, and the vibration applying unit 88 that applies vibration to the abutting portions, the abutting portions include the first abutting portion 2 and the second abutting portion 3 disposed with the fabric M interposed therebetween, and the vibration applying unit 88 includes the first driving unit 51 that applies vibration to the first abutting portion 2 and the second driving unit 52 that applies vibration to the second abutting portion 3. Then, the first driving unit 51 and the second driving unit 52 operate synchronously. The first driving unit 51 and the second driving unit 52 are each configured by the scotch yoke mechanism.

FIG. 6 includes graphs showing driving modes of the first driving unit and the second driving unit by waveforms. In FIG. 6, a horizontal axis represents time and a vertical axis represents drive amplitude (drive voltage).

A graph 151 shown in FIG. 6 indicates the driving mode of the first driving unit 51, and a graph 152 indicates the driving mode of the second driving unit 52. As shown in the graphs 151 and 152, it is understood that a waveform of vibration applied to the first abutting portion 2 by the first driving unit 51 and a waveform of vibration applied to the second abutting portion 3 by the second driving unit 52 are in opposite phases.

As described above, the first abutting portion 2 and the second abutting portion 3 perform abutting and separation from both sides of the fabric M synchronously, so that movement of a center of gravity in the processing device 100 is canceled out and the vibration is reduced. According to results of experiments by the present inventors, it has been confirmed that large vibrations do not occur even when high-speed driving is performed.

Note that the frequency in the graphs 151 and 152 in a preferred example is from 1 Hz to 100 Hz. Further, driving amounts of the first abutting portion 2 and the second abutting portion 3 are from 1 mm to 10 mm. Note that these numerical values are examples, and it is sufficient that the values are appropriately set according to a type of the fabric M and a printing state. In addition, the waveforms in the graphs 151 and 152 are not limited to a sine wave, and may be a rectangular wave, a triangular wave, or a waveform obtained by combining these waves as long as both the waveforms are in an opposite phase relationship.

### Aspect of Protruding Portion

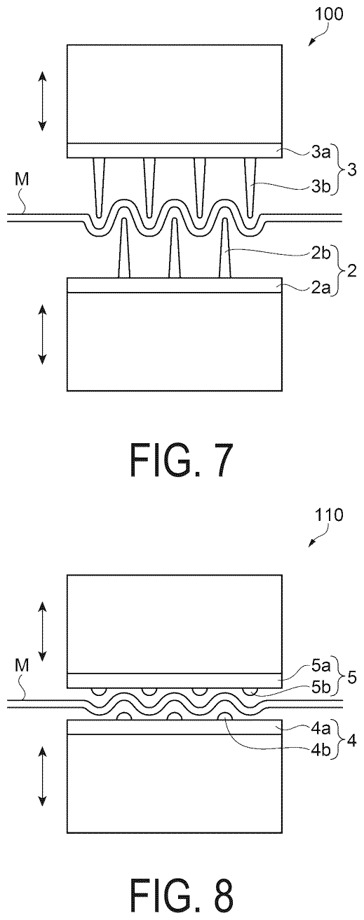

FIG. 7 is a side view illustrating an aspect of the protruding portion of the first processing device, and corresponds to FIG. 1. FIG. 8 is a side view illustrating an aspect of the protruding portion of the second processing device, and corresponds to FIG. 1.

As illustrated in FIG. 7, the protruding portion 2b of the first abutting portion 2 of the processing device 100 is a conical protruding portion made of metal and having a round tip. The protruding portion 3b of the second abutting portion 3 is also the same protruding portion as the protruding portion 2b. By striking the fabric M from the front and back with the protruding portion 2b and the protruding portion 3b, the fabric M is deformed so as to be waved, and stiffness of the fabric M is reduced. Further, an ink layer and a resin layer are partially broken down by the tips of the protruding portions 2b and 3b. The processing by the processing device 100 corresponds to rough processing, softens the ink layer and the resin layer that causes the stiffness of the printed fabric M, and partially breaks down the layers.

As illustrated in FIG. 8, a protruding portion 4b of the third abutting portion 4 of the processing device 110 is a protruding portion made of metal and having a rounded shape such as a convex spherical shape or a wavy curved shape. A protruding portion 5b of the fourth abutting portion 5 is also the same protrusion as the protruding portion 4b. The protruding portions 4b and the protruding portions 5b are alternately disposed in plan view. By interposing the fabric M from the front and back with the protruding portion 4b and the protruding portion 5b, a rough processed surface disturbed by the rough processing is smoothed. The processing by the processing device 110 corresponds to finish processing, and smooths a surface layer of the fabric M to have a desired texture.

In other words, the shapes of the protruding portions 2b and 3b provided at the first abutting portion 2 and the second abutting portion 3 are different from the shapes of the protruding portions 4b and 5b provided at the third abutting portion 4 and the fourth abutting portion 5.

### About Texture Processing

The texture processing treatment performed by the processing devices 100 and 110 will be described.

First, texture means a feel of a material such as a feel by a hand or skin. In the fabric M after printing, an original texture and quality of the fabric M tends to deteriorate, and improvement of the deterioration is required.

In the processing devices 100 and 110, the fabric M is subjected to at least one type of processing selected from bending, striking, stretching, and rubbing.

The bending refers to processing of repeating a deformation operation in which a bending angle of a fiber is increased. By the bending, relaxation of association force between parallel fibers in the fabric M, release of bonding points of intersecting fiber bundles, and partial structural destruction of the fibers progress, so that stiff feeling of the fabric is reduced and the feel of the material can be enhanced. The striking refers to processing of striking the fabric M from both the front and back surfaces with the protruding portions. By the striking, compression and restoration of the fiber bundles of the fabric M are repeated, and disturbance of an array among the parallel fibers, an intersection-position shift of the intersecting fiber bundles, and the partial structural destruction of fibers progress, and enlargement of gaps between the fibers, enlargement of distances between the fiber bundles, and fluffing due to cutting of a part of the fibers progress, so that bulky feeling of the fabric increases and the texture of the fabric can be enhanced.

The stretching refers to formation of a residual strain in a form of minute embosses in a non-stretchable fabric as the fabric M repeats stretching and shrinking operation. The residual strain in the form of minute embosses has an effect of improving bulkiness in the non-stretchable fabric M.

The rubbing refers to processing of fluffing the fibers of the fabric M. The rubbing is also called raising treatment. By fluffing the fibers, a better texture can be obtained.

The fibers constituting the fabric M are not particularly limited, and examples thereof include natural fibers such as cotton, hemp, wool, and silk, synthetic fibers such as polypropylene, polyester, acetate, triacetate, polyamide, and polyurethane, biodegradable fibers such as polylactic acid, and mixed fibers thereof.

Examples of coloring material with which the fabric is colored in advance include a pigment, a water-soluble dye such as an acid dye or a basic dye, a disperse dye in combination with a dispersant, and a reactive dye. When a cotton fabric is used as the fabric, a reactive dye or pigment suitable for dyeing cotton may be used. When a pigment is used, it is desirable in that coloring of relatively various kinds of fabrics can be supported.

The fabric M colored by using a pigment is likely to deteriorate in texture due to presence of a large amount of a solid content such as a resin binder. In particular, in the fabric M to which ink is attached and heat-fixed by a recording method using a printing pigment ink composition containing a urethane-based resin dispersion having a crosslinkable group, the fabric M may become film-like. However, by performing the processing by the processing devices 100 and 110 of the embodiment, it is possible to remarkably enhance the texture.

As described above, according to the processing devices 100, 110, and the printing apparatus 200 of the embodiment, the following advantages can be obtained.

The processing device 100 is a processing device that performs the texture processing treatment on the printed fabric M, and includes the abutting portions including the plurality of protruding portions 2a and 3b that abut on the fabric M, and the vibration applying unit 88 configured to apply vibration to the abutting portions, wherein the abutting portions include the first abutting portion 2 and the second abutting portion 3 disposed with the fabric M interposed therebetween, the vibration applying unit 88 includes the first driving unit 51 that applies vibration to the first abutting portion 2 and the second driving unit 52 that applies vibration to the second abutting portion 3, and a waveform of the vibration applied to the first abutting portion 2 by the first driving unit 51 and a waveform of the vibration applied to the second abutting portion 3 by the second driving unit 52 are opposite in phase.

With this, since the first abutting portion 2 and the second abutting portion 3 facing each other with the fabric M interposed therebetween are driven in opposite phases, movement of the center of gravity in the entire processing device 100 is canceled out, and the vibration is reduced. Therefore, it is possible to provide the processing devices 100 and 110 with less vibration and vibration sound and a high degree of freedom in installation environment.

Further, the first driving unit 51 and the second driving unit 52 are each configured by the scotch yoke mechanism.

With this, it possible to configure the driving unit and the processing device with a simple configuration. Further, since the toothed gear 81 and the toothed gear 82 for distributing driving force are provided at input portions of the respective driving units, the two driving units of the first driving unit 51 and the second driving unit 52 can be configured to be drivable by one driving motor 50. In addition, since the toothed gear 82 rotates in the direction opposite to the rotation direction of the toothed gear 81, the second driving unit 52 can be driven in the phase opposite to that of the first driving unit 51 with a simple configuration.

Further, the first driving unit 51 and the second driving unit 52 operate synchronously.

With this, since the first abutting portion 2 and the second abutting portion 3 operate so as to cancel out each other's movement, it is possible to reduce vibration and vibration sound.

The printing apparatus 200 includes the processing devices 100, 110, and the printing unit 10 that performs printing on the fabric M, and when the processing device 100 including the first abutting portion 2 and the second abutting portion 3 is defined as the first processing device, the printing apparatus 200 further includes the processing device 110 as the second processing device disposed downstream of the processing device 100 in the transport direction of the fabric M, and the processing device 110 includes the third abutting portion 4 and the fourth abutting portion 5 disposed with the fabric M interposed therebetween.

With this, the printing apparatus 200 includes the processing devices 100 and 110 with less vibration and vibration sound and a high degree of freedom in installation environment.

Therefore, it is possible to provide the printing apparatus 200 with less vibration and vibration sound and a high degree of freedom in installation environment.

In addition, the shapes of the protruding portions 2b and 3b provided at the first abutting portion 2 and the second abutting portion 3 are different from the shapes of the protruding portions 4b and 5b provided at the third abutting portion 4 and the fourth abutting portion 5.

With this, the printing apparatus 200 can include the processing device 100 for rough processing and the processing device 110 for finish processing. Therefore, it is possible to provide the printing apparatus 200 capable of performing desired texture processing treatment.

### Embodiment 2

### Different Disposition Mode of Processing Device

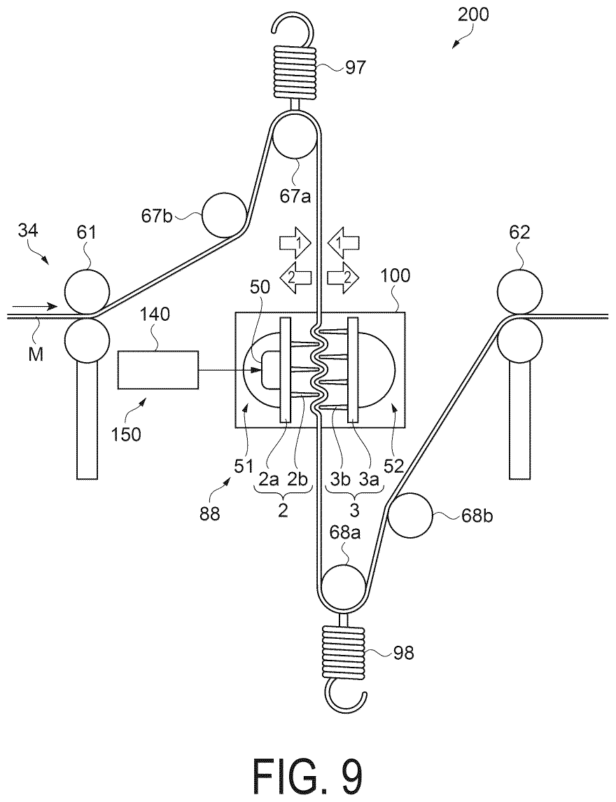

FIG. 9 is a diagram illustrating a disposition mode of a processing device according to Embodiment 2, and corresponds to FIG. 2. In the above-described embodiment, the installation mode of the processing device 100 is adopted in which vibration is applied by the first abutting portion 2 and the second abutting portion 3 to the fabric M transported in a horizontal direction from above and below, but the present disclosure is not limited thereto, and the processing device 100 may be installed such that the first abutting portion 2 and the second abutting portion 3 apply vibration to the fabric M transported in a vertical direction from left and right. The same constituent portions as those in the above-described embodiment are given the same reference signs, and overlapping description thereof will be omitted.

As illustrated in FIG. 9, in the installation mode of the embodiment, the processing device 100 is installed such that the fabric M is transported from above to below in the vertical direction, and the first abutting portion 2 and the second abutting portion 3 apply vibration to the fabric M from left and right. In other words, the first driving unit 51 and the second driving unit 52 are disposed side by side in the horizontal direction so as to face each other.

In order to change the transport direction of the fabric M, an upper roller 67a for lifting, an adjustment roller 67b, a lower roller 68a, and an adjustment roller 68b are provided.

After horizontally transported to the roller pair 61, the fabric M is lifted up toward the upper roller 67a, and a transport angle is adjusted by the adjustment roller 67b on the way. The upper roller 67a is suspended by a coil spring 97, and tensile force of the fabric M is adjusted. As illustrated in FIG. 9, the fabric M is transported downward in the vertical direction while turning at the upper roller 67a.

After the texture processing treatment is performed by the processing device 100, the fabric M turns at the lower roller 68a, and then the transport angle thereof is adjusted by the adjustment roller 68b on the way, and the fabric M is lifted up toward the roller pair 62. A coil spring 98 is attached to the lower roller 68a, and the tensile force of the fabric M is adjusted. The fabric M passing through the roller pair 62 is transported in the horizontal direction. Although the processing device 100 has been described in the above as an example, the description can be similarly applied to the processing device 110.

As described above, according to the processing devices 100, 110, and the printing apparatus 200 of the embodiment, the following advantages can be obtained.

According to the processing device 100 of the embodiment, the first driving unit 51 and the second driving unit 52 are disposed side by side in the horizontal direction so as to face each other, and vibration is applied to the fabric M from left and right by the first abutting portion 2 and the second abutting portion 3.

With this, it is possible to reduce a size of the processing device 100. In particular, in the installation mode, the processing device 100 can be configured to be compact in the width direction. Therefore, when the processing device 100 is mounted at the printing apparatus 200, it is possible to reduce a size of the printing apparatus 200. When the processing device 110 is installed in the same manner as the processing device 100, it is possible to further reduce the size of the printing apparatus 200.

Further, in addition to the vibration cancellation effect due to the fact that the first abutting portion 2 and the second abutting portion 3 are disposed to face each other and are driven in opposite phases, since there is no influence of gravity, the vibration is further reduced.

Therefore, it is possible to provide the processing devices 100, 110, and the printing apparatus 200 that are small in size, with less vibration and vibration sound, and a high degree of freedom in installation environment.

### Modifications

Description will be given using FIG. 3.

When the width of the fabric M is large, it is assumed that it is difficult to drive the two driving units by the driving force of one driving motor 50. In this case, the first driving unit 51 and the second driving unit 52 may be driven independently. Specifically, the transmission mechanism including the toothed gear 81 and the toothed gear 82 is not used, and the first driving unit 51 and the second driving unit 52 are independently and respectively provided with driving motors. A drive signal according to the graph 151 in FIG. 6 and a drive signal according to the graph 152 are individually applied to the respective motors.

Even with the processing device having such a configuration, the same effects as those in the above-described embodiments can be obtained.

What is claimed is:

1. A processing device that performs texture processing treatment on a printed fabric, comprising:
an abutting portion including a plurality of protruding portions that abut on the fabric; and
a vibration applying unit configured to apply vibration to the abutting portion, wherein
the abutting portion includes a first abutting portion and a second abutting portion disposed with the fabric interposed therebetween,
the vibration applying unit includes a first driving unit that applies vibration to the first abutting portion and a second driving unit that applies vibration to the second abutting portion, and
a waveform of the vibration applied to the first abutting portion by the first driving unit and a waveform of the vibration applied to the second abutting portion by the second driving unit are opposite in phase.

2. The processing device according to claim 1, wherein
the first driving unit and the second driving unit include a scotch yoke mechanism.

3. The processing device according to claim 2, wherein
The first driving unit and the second driving unit synchronously operate.

4. The processing device according to claim 1, wherein
the first driving unit and the second driving unit are disposed side by side in a horizontal direction so as to face each other.

5. A printing apparatus, comprising:
the processing device according to claim 1; and
a printing unit configured to perform printing on the fabric, and further comprising:
when the processing device including the first abutting portion and the second abutting portion is defined as a first processing device, a second processing device disposed downstream of the first processing device in a transport direction of the fabric, wherein
the second processing device includes a third abutting portion and a fourth abutting portion disposed with the fabric interposed therebetween.

6. The printing apparatus according to claim 5, wherein
a shape of the protruding portion provided at the first abutting portion and the second abutting portion is different from a shape of the protruding portion provided at the third abutting portion and the fourth abutting portion.
